(19) United States
(12) Patent Application Publication
(10) Pub. No.: US 2024/0413367 A1
(43) Pub. Date: Dec. 12, 2024

(54) ELECTROLYTE SUBSTRATE FOR SOLID OXIDE FUEL CELL, SINGLE CELL FOR SOLID OXIDE FUEL CELL, SOLID OXIDE FUEL CELL STACK, AND METHOD FOR MANUFACTURING ELECTROLYTE SUBSTRATE FOR SOLID OXIDE FUEL CELL

(71) Applicant: Murata Manufacturing Co., Ltd., Nagaokakyo-shi (JP)

(72) Inventors: Hiroaki YAMADA, Nagaokakyo-shi (JP); Seiji FUJITA, Nagaokakyo-shi (JP)

(21) Appl. No.: 18/809,656

(22) Filed: Aug. 20, 2024

Related U.S. Application Data
(63) Continuation of application No. PCT/JP2023/012143, filed on Mar. 27, 2023.

(30) Foreign Application Priority Data
Apr. 4, 2022 (JP) 2022-062453

(51) Int. Cl. H01M 8/1226; H01M 8/12; H01M 8/1253; H01M 8/2425

(52) U.S. Cl. CPC H01M 8/1226; H01M 8/1253; H01M 8/2425; H01M 2008/1293

(57) ABSTRACT

An electrolyte substrate for solid oxide fuel cells that includes: an electrolyte layer containing sintered scandia-stabilized zirconia or sintered yttria-stabilized zirconia; and a first barrier layer on a first main surface of the electrolyte layer, and a second barrier layer on a second main surface of the electrolyte layer, each of the first barrier layer and the second barrier layer containing sintered Ce(X)O₂, where X is any one of Sm, Gd, and Y, wherein in a cross-sectional view in a thickness direction of the first barrier layer and the second barrier layer, pores are present with an area percentage of 24% to 72% in each of the first barrier layer and the second barrier layer.

### CROSS REFERENCE TO RELATED APPLICATIONS

The present application is a continuation of International application No. PCT/JP2023/012143, filed Mar. 27, 2023, which claims priority to Japanese Patent Application No. 2022-062453, filed Apr. 4, 2022, the entire contents of each of which are incorporated herein by reference.

### TECHNICAL FIELD

The present disclosure relates to an electrolyte substrate for solid oxide fuel cells, a unit cell for solid oxide fuel cells, a solid oxide fuel cell stack, and a method for producing an electrolyte substrate for solid oxide fuel cells.

### BACKGROUND ART

A solid oxide fuel cell (SOFC) is a device that produces electric energy through reactions of H₂+O²⁻→H₂O+2e⁻at a fuel electrode and (½)O₂+2e⁻→O²⁻ at an air electrode. A solid oxide fuel cell for use has a layered structure in which multiple unit cells for solid oxide fuel cells are stacked, each unit cell including an electrolyte substrate for solid oxide fuel cells, and a fuel electrode and an air electrode on the electrolyte substrate.

JP 3789380 B (“Patent Literature 1”) discloses a solid oxide fuel cell including a fuel electrode and an air electrode with an electrolyte membrane therebetween, wherein an intermediate layer made of Ce(X)O₂ (where X is any one of Sm, Gd, and Y) is between the electrolyte membrane made of scandia-stabilized zirconia and the air electrode made of La(Ni) FeO₃.

Patent Literature 1 also discloses a method for producing a solid oxide fuel cell, the method including: forming a fuel electrode on one surface of an electrolyte membrane made of scandia-stabilized zirconia; applying a slurry made of Ce(X)O₂ (where X is any one of Sm, Gd, and Y) to the other surface of the electrolyte membrane and sintering the slurry to form an intermediate layer; and disposing an air electrode made of La(Ni)FeO₃. Patent Literature 1 also discloses a method of producing a solid oxide fuel cell, the method including: forming an electrolyte membrane of scandia-stabilized zirconia on a fuel electrode and sintering the electrolyte membrane; applying a slurry made of Ce(X)O₂ (where X is any one of Sm, Gd, and Y) to the electrolyte membrane and sintering the slurry to form an intermediate layer; and disposing an air electrode made of La(Ni)FeO₃.

### SUMMARY OF THE DISCLOSURE

According to Patent Literature 1, forming the intermediate layer of Ce(Sm)O₂ or the like between the air electrode of La(Ni)FeO₃ and the zirconia-based electrolyte makes it possible to control a reaction between La(Ni)FeO₃ as the air electrode and zirconia in the electrolyte during electrode sintering so as to improve cell performance.

In order to form an intermediate layer (hereinafter described as “barrier layer”) as described in Patent Literature 1, the electrolyte layer and the barrier layer are co-sintered or the barrier layer is post-baked on the sintered electrolyte layer. However, during such a process, cracking may occur in the electrolyte layer and/or the barrier layer due to the difference in thermal expansion or firing shrinkage between the materials. The cracking, when occurs, causes problems such as a decrease in strength of the electrolyte layer, a decrease in long-term reliability (durability) as the cell after electrode formation, and a decrease in power generation characteristics due to a decrease in function to separate between an oxidizing gas and a fuel gas.

The present disclosure was made to solve the above issues and aims to provide an electrolyte substrate for solid oxide fuel cells, wherein the difference in thermal expansion or firing shrinkage between an electrolyte layer and a barrier layer is reduced, making it possible to prevent or reduce cracking. The present disclosure also aims to provide a unit cell for solid oxide fuel cells, the unit cell including the electrolyte substrate; a solid oxide fuel cell stack of the unit cells in multiple layers; and a method for producing the electrolyte substrate.

The electrolyte substrate for solid oxide fuel cells according to the present disclosure includes: an electrolyte layer containing sintered scandia-stabilized zirconia or sintered yttria-stabilized zirconia, and a first barrier layer on a first main surface of the electrolyte layer, and a second barrier layer on a second main surface of the electrolyte layer, each of the first barrier layer and the second barrier layer containing sintered Ce(X)O₂, where X is any one of Sm, Gd, and Y, wherein in a cross-sectional view in a thickness direction of the first barrier layer and the second barrier layer, pores are present with an area percentage of 24% to 72% in each of the first barrier layer and the second barrier layer.

The unit cell for solid oxide fuel cells according to the present disclosure includes an air electrode; a fuel electrode; and the electrolyte substrate according to the present disclosure between the air electrode and the fuel electrode, wherein at least one of the first barrier layer and the second barrier layer of the electrolyte substrate is between the electrolyte layer of the electrolyte substrate and the air electrode.

The solid oxide fuel cell stack according to the present disclosure includes cells in multiple layers, each cell including the unit cell according to the present disclosure; a first interconnector adjacent to the air electrode of the unit cell; and a second interconnector adjacent to the fuel electrode of the unit cell.

The method for producing an electrolyte substrate for solid oxide fuel cells according to the present disclosure includes: producing an unsintered substrate including a first unsintered barrier layer on a first main surface of an unsintered electrolyte layer or on a first main surface of a sintered electrolyte layer, and a second unsintered barrier layer on a second main surface of an unsintered electrolyte layer or on a second main surface of a sintered electrolyte layer, each of the first unsintered barrier layer and the second unsintered barrier layer containing Ce(X)O₂ powder, where X is any one of Sm, Gd, and Y, and a burning-out material, the unsintered electrolyte layer containing scandia-stabilized zirconia powder or yttria-stabilized zirconia powder, the sintered electrolyte layer containing sintered scandia-stabilized zirconia or sintered yttria-stabilized zirconia; and firing the unsintered substrate at least at a temperature at which the burning-out material is burned out.

The present disclosure can provide an electrolyte substrate for solid oxide fuel cells, wherein the difference in thermal expansion or firing shrinkage between an electrolyte layer and a barrier layer is reduced, making it possible to prevent or reduce cracking. The present disclosure can also provide a unit cell for solid oxide fuel cells, the unit cell including the electrolyte substrate; a solid oxide fuel cell stack of the unit cells in multiple layers; and a method for producing the electrolyte substrate.

### BRIEF DESCRIPTION OF THE DRAWINGS

FIG. 1 is a schematic cross-sectional view of an example of an electrolyte substrate for solid oxide fuel cells according to the present disclosure.

FIG. 2 is a schematic cross-sectional view of another example of the electrolyte substrate for solid oxide fuel cells according to the present disclosure.

FIG. 3 is a schematic cross-sectional view showing an example of producing an electrolyte layer green sheet.

FIG. 4 is a schematic cross-sectional view showing an example of producing a barrier layer green sheet.

FIG. 5 is a schematic cross-sectional view showing an example of producing an unsintered substrate.

FIG. 6 is a schematic cross-sectional view showing another example of the producing an unsintered substrate.

FIG. 7 is a schematic cross-sectional view showing an example of firing the unsintered substrate.

FIG. 8 is a schematic cross-sectional view showing another example of the firing the unsintered substrate.

FIG. 9 is a schematic cross-sectional view of an example of a unit cell for solid oxide fuel cells according to the present disclosure.

FIG. 10 is a schematic cross-sectional view of another example of the unit cell for solid oxide fuel cells according to the present disclosure.

FIG. 11 is an exploded perspective view of an example of a solid oxide fuel cell stack according to the present disclosure.

### DESCRIPTION OF THE PREFERRED EMBODIMENTS

Hereinafter, an electrolyte substrate for solid oxide fuel cells, a unit cell for solid oxide fuel cells, a solid oxide fuel cell stack, and a method for producing an electrolyte substrate for solid oxide fuel cells according to the present disclosure are described. The present disclosure is not limited to the following preferred embodiments and may be appropriately modified without departing from the gist of the present disclosure. Combinations of two or more preferred features described in the following preferred embodiments are also within the scope of the present disclosure.

The drawings are schematic drawings, and the dimensions, the aspect ratio, the scale, and other parameters may differ from those of the actual products.

### Electrolyte Substrate for Solid Oxide Fuel Cells

The electrolyte substrate for solid oxide fuel cells according to the present disclosure includes an electrolyte layer containing sintered scandia-stabilized zirconia or sintered yttria-stabilized zirconia and a barrier layer disposed on at least one main surface of the electrolyte layer and containing sintered Ce(X)O₂, where X is any one of Sm, Gd, and Y, wherein in a cross-sectional view in a thickness direction of the barrier layer, pores are present with an area percentage of 24% to 72% in the barrier layer.

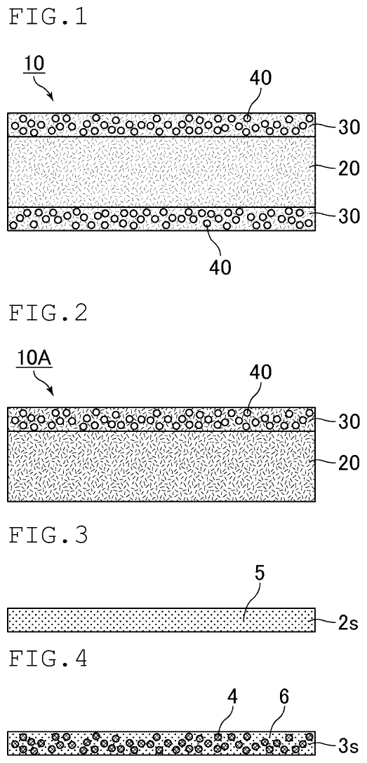

FIG. 1 is a schematic cross-sectional view of an example of the electrolyte substrate for solid oxide fuel cells according to the present disclosure.

An electrolyte substrate 10 for solid oxide fuel cells shown in FIG. 1 includes an electrolyte layer 20 and a barrier layer 30 on each main surface of the electrolyte layer 20.

FIG. 2 is a schematic cross-sectional view of another example of the electrolyte substrate for solid oxide fuel cells according to the present disclosure.

An electrolyte substrate 10A for solid oxide fuel cells shown in FIG. 2 includes the electrolyte layer 20 and the barrier layer 30 on one main surface of the electrolyte layer 20.

The electrolyte layer 20 contains sintered scandia-stabilized zirconia or sintered yttria-stabilized zirconia.

Examples of the scandia-stabilized zirconia include Zr(Sc)O₂ and Zr(Sc,M)O₂, where M is any one of Al₂O₃, CeO₂, and Y₂O₃.

Examples of the yttria-stabilized zirconia include Zr(Y)O₂.

The barrier layer 30 contains sintered Ce(X)O₂, where X is any one of Sm, Gd, and Y. The barrier layer 30 on each main surface of the electrolyte layer 20 may consist of two or more layers but preferably consists of a single layer.

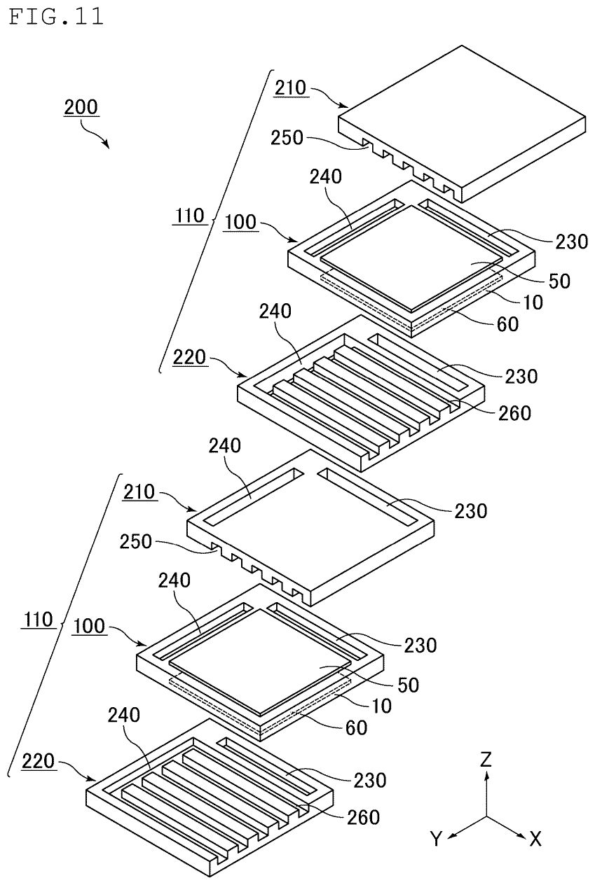

Similarly to the intermediate layer disclosed in Patent Literature 1, the barrier layer 30 has a function to prevent a reaction between the electrolyte layer 20 and an air electrode 50 (see FIG. 9 and FIG. 10 described later).

As shown in FIG. 1 and FIG. 2, pores 40 are present in the barrier layer 30.

Owing to the pores 40 in the barrier layer 30, the difference in thermal expansion or firing shrinkage between the electrolyte layer 20 and the barrier layer 30 is reduced, making it possible to prevent or reduce cracking.

In contrast, when the pores formed in the electrolyte layer 20 are connected to each other and penetrate the electrolyte layer 20, a decrease in power generation characteristics occurs due to loss of the function to separate between an oxidizing gas and a fuel gas. Thus, the pores 40 are preferably formed in the barrier layer 30.

When the shrinkage of the electrolyte layer 20 is greater than the shrinkage of the barrier layer 30, the difference in firing shrinkage can be effectively reduced by forming the pores 40 in the barrier layer 30.

When the thermal expansion coefficient of the electrolyte layer 20 is lower than the thermal expansion coefficient of the barrier layer 30, the difference in thermal expansion can be effectively reduced by forming the pores 40 in the barrier layer 30.

Further, as shown in Examples described later, the strength of the substrate was found to improve as the number of the pores 40 in the barrier layer 30 increased. Presumably, this is due to effects such as a reduction in residual stress (i.e., tensile stress to the surface of the barrier layer 30) owing to the reduction in the difference in thermal expansion during firing, and stoppage of crack growth with the pores 40 even in the event of cracking.

In contrast, when the number of the pores 40 in the barrier layer 30 is too large, the barrier layer 30 is easily separated from the electrolyte layer 20. Presumably, this is caused by a decrease in the area where the electrolyte layer 20 and the barrier layer 30 are bonded together, and also by a decrease in strength of the barrier layer 30 itself.

Based on the above reasons, in a cross-sectional view in a thickness direction of the barrier layer 30, the pores 40 are desirably present with an area percentage of 24% to 72% in the barrier layer 30. In other words, desirably, the porous area percentage in the barrier layer 30 is 24% to 72%.

The thickness of the barrier layer 30 is not limited and may be the same as the thickness of the electrolyte layer 20, greater than the thickness of the electrolyte layer 20, or smaller than the thickness of the electrolyte layer 20. Yet, since cracking is more likely to occur as the ratio of the thickness of the barrier layer 30 to the thickness of the electrolyte layer 20 is higher, the effect of the pores 40 is more significant when the ratio is higher. Meanwhile, a decrease in power generation characteristics is more likely to occur as the ratio of the thickness of the barrier layer 30 to the thickness of the electrolyte layer 20 is higher. Thus, in order to provide power generation characteristics, the ratio of the thickness of the barrier layer 30 to the thickness of the electrolyte layer 20 is preferably 20% or less. Meanwhile, in terms of the strength of the barrier layer 30 itself, adhesion between the barrier layer 30 and the electrolyte layer 20, and exertion of the function of the barrier layer 30, the ratio of the thickness of the barrier layer 30 to the thickness of the electrolyte layer 20 may be 1% or more, for example, but is preferably 5% or more, more preferably 10% or more.

For example, the thickness of the barrier layer 30 is preferably 20 μm or less. At the same time, the thickness of the barrier layer 30 may be 1 μm or more but is preferably 5 μm or more, more preferably 10 μm or more. When the thickness of the barrier layer 30 is in the above range, the thickness of the electrolyte layer 20 is preferably 80 μm to 120 μm. When the thickness of the barrier layer 30 is in the above range, the ratio of the thickness of the barrier layer 30 to the thickness of the electrolyte layer 20 is preferably in the above range.

In each of the case where the barrier layer 30 is on each main surface of the electrolyte layer 20 as shown in FIG. 1 and the case where the barrier layer 30 is on one main surface of the electrolyte layer 20 as shown in FIG. 2, the thickness of the barrier layer 30 refers to the thickness of the barrier layer 30 on each main surface of the electrolyte layer 20 (i.e., the thickness of a single layer).

The shape, size, and the like of the pores 40 are not limited. The pores 40 may have the same shape or different shapes. Similarly, the pores 40 may have the same size or different sizes.

For example, while some of the pores 40 may be connected to each other, when the pores 40 are connected to each other and penetrate the barrier layer 30, a reaction may occur between the electrolyte layer 20 and the air electrode 50 (see FIG. 9 and FIG. 10 described later), and it may be difficult to sufficiently achieve the effect of stopping crack growth with the pores 40 in the event of cracking. Thus, preferably, the pores 40 are not continuous from one surface to the other surface that are opposite to each other in the thickness direction of the barrier layer 30.

Preferably, the pores 40 are uniformly distributed in the barrier layer 30. In other words, preferably, the pores 40 are not unevenly distributed in the barrier layer 30.

As shown in FIG. 1, when the barrier layer 30 is on each main surface of the electrolyte layer 20, preferably, the thickness, porous area percentage, and the like are the same between these barrier layers 30. The term “same” as used herein does not mean exactly the same, as long as the difference is within a range of about 3%. Warpage and the like during sintering can be prevented or reduced by disposing the barrier layers 30 symmetrically relative to the electrolyte layer 20.

The shape, size, thickness, and the like of the electrolyte substrates 10 and 10A are not limited.

Method for Producing Electrolyte Substrate for Solid Oxide Fuel Cells

The method for producing an electrolyte substrate for solid oxide fuel cells according to the present disclosure includes: producing an unsintered substrate including an unsintered barrier layer on at least one main surface of an unsintered electrolyte layer or on at least one main surface of a sintered electrolyte layer, the unsintered barrier layer containing Ce(X)O₂ powder, where X is any one of Sm, Gd, and Y, and a burning-out material, the unsintered electrolyte layer containing scandia-stabilized zirconia powder or yttria-stabilized zirconia powder, the sintered electrolyte layer containing sintered scandia-stabilized zirconia or sintered yttria-stabilized zirconia; and firing the unsintered substrate at least at a temperature at which the burning-out material is burned out.

The producing an unsintered substrate may include producing an unsintered substrate including an unsintered barrier layer containing Ce(X)O₂ powder, where X is any one of Sm, Gd, and Y, and a burning-out material on at least one main surface of the unsintered electrolyte layer containing scandia-stabilized zirconia powder or yttria-stabilized zirconia powder. In this case, a barrier layer is formed by co-sintering with the unsintered electrolyte layer.

The unsintered electrolyte layer may be formed by, for example, a method for producing an electrolyte layer green sheet or a method for applying an electrolyte layer paste. The unsintered barrier layer may be formed by, for example, a method for producing a barrier layer green sheet or a method for applying a barrier layer paste.

For example, the producing an unsintered substrate includes producing an unfired electrolyte layer green sheet containing scandia-stabilized zirconia powder or yttria-stabilized zirconia powder; producing an unfired barrier layer green sheet containing Ce(X)O₂ powder, where X is any one of Sm, Gd, and Y, and a burning-out material; and stacking the electrolyte layer green sheet and the barrier layer green sheet.

Alternatively, the producing an unsintered substrate may include producing an unsintered substrate including an unsintered barrier layer containing Ce(X)O₂ powder, where X is any one of Sm, Gd, and Y, and a burning-out material on at least one main surface of the sintered electrolyte layer containing sintered scandia-stabilized zirconia or sintered yttria-stabilized zirconia. In this case, a barrier layer is formed by post-baking on a sintered electrolyte layer.

In the method for producing an electrolyte substrate according to the present disclosure, pores are intentionally formed in the barrier layer. Specifically, the pores are formed by adding a burning-out material (material that is burned out during firing) in advance into the barrier layer green sheet or a barrier layer paste.

Examples of the burning-out material include resin beads, carbon, binders, and other organic substances. One burning-out material or two or more burning-out materials may be used. In particular, resin beads are preferred as the burning-out material. Use of resin beads as the burning-out material can facilitate adjustment of the pore shape.

Hereinafter, an example of a method for producing the electrolyte substrate 10 shown in FIG. 1 or the electrolyte substrate 10A shown in FIG. 2 is described for each step, with reference to the drawings.

FIG. 3 is a schematic cross-sectional view showing an example of producing an electrolyte layer green sheet.

For example, an unfired electrolyte layer green sheet 2s is produced by molding an electrolyte layer ceramic slurry. The electrolyte layer green sheet 2s contains scandia-stabilized zirconia or yttria-stabilized zirconia powder 5.

The electrolyte layer ceramic slurry can be prepared, for example, by blending scandia-stabilized zirconia powder or yttria-stabilized zirconia powder, a binder, a dispersant, an organic solvent, and the like.

FIG. 4 is a schematic cross-sectional view showing an example of producing a barrier layer green sheet.

For example, an unfired barrier layer green sheet 3s is produced by molding a barrier layer ceramic slurry. The barrier layer green sheet 3s contains Ce(X)O₂ powder 6, where X is any one of Sm, Gd, and Y, and a burning-out material 4.

The barrier layer ceramic slurry can be prepared by, for example, mixing Ce(X)O₂ powder, where X is any one of Sm, Gd, and Y, a burning-out material, a binder, a dispersant, an organic solvent, and the like.

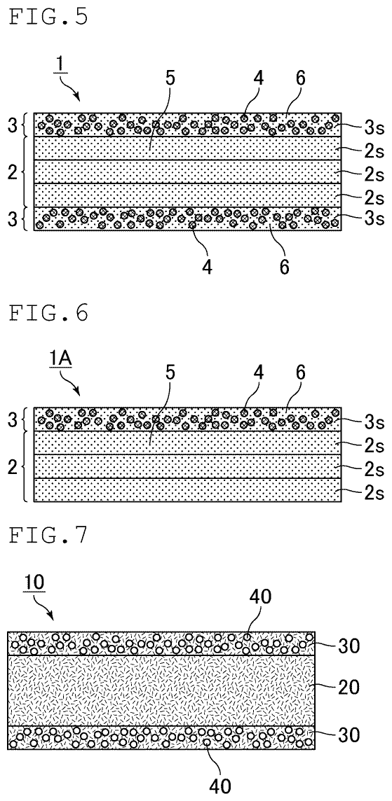

FIG. 5 is a schematic cross-sectional view showing an example of producing an unsintered substrate.

As shown in FIG. 5, the electrolyte layer green sheets 2s and the barrier layer green sheet 3s are stacked, whereby an unsintered substrate 1 is produced. The unsintered substrate 1 shown in FIG. 5 includes the unsintered barrier layer 3 on each main surface of an unsintered electrolyte layer 2.

In the example shown in FIG. 5, the unsintered substrate 1 is produced by stacking one barrier layer green sheet 3s, three electrolyte layer green sheets 2s, and one barrier layer green sheet 3s in the stated order. The number of the electrolyte layer green sheets 2s in the unsintered electrolyte layer 2 is not limited. The number may be one or two or more. The number of the barrier layer green sheets 3s in the unsintered barrier layer 3 on one main surface of the unsintered electrolyte layer 2 is not limited. The number may be one or two or more. The number of the barrier layer green sheets 3s included in the unsintered barrier layer 3 on one main surface of the unsintered electrolyte layer 2 may be the same as or more or less than the number of the electrolyte layer green sheets 2s included in the unsintered electrolyte layer 2. Similarly, the number of the barrier layer green sheets 3s in the unsintered barrier layer 3 on the other main surface of the unsintered electrolyte layer 2 is not limited. The number may be one or two or more. The number of the barrier layer green sheets 3s included in the unsintered barrier layer 3 on the other main surface of the unsintered electrolyte layer 2 may be the same as or more or less than the number of the electrolyte layer green sheets 2s included in the unsintered electrolyte layer 2. The number of the barrier layer green sheets 3s included in the unsintered barrier layer 3 on the other main surface of the unsintered electrolyte layer 2 may be the same as or more or less than the number of the barrier layer green sheets 3s included in the unsintered barrier layer 3 on one main surface of the unsintered electrolyte layer 2.

FIG. 6 is a schematic cross-sectional view showing another example of the producing an unsintered substrate.

As shown in FIG. 6, an unsintered substrate 1A may be produced by stacking the electrolyte layer green sheets 2s and the barrier layer green sheet 3s. The unsintered substrate 1A shown in FIG. 6 includes the unsintered barrier layer 3 on one main surface of the unsintered electrolyte layer 2.

In the example shown in FIG. 6, the unsintered substrate 1A is produced by stacking one barrier layer green sheet 3s and three electrolyte layer green sheets 2s in the stated order. The number of the electrolyte layer green sheets 2s in the unsintered electrolyte layer 2 is not limited. The number may be one or two or more. The number of the barrier layer green sheets 3s in the unsintered barrier layer 3 on one main surface of the unsintered electrolyte layer 2 is not limited. The number may be one or two or more.

When forming the unsintered electrolyte layer 2, the thickness of the unsintered electrolyte layer 2 can be easily controlled by stacking multiple electrolyte layer green sheets 2s. Similarly, when forming the unsintered barrier layer 3, the thickness of the unsintered barrier layer 3 can be easily controlled by stacking multiple barrier layer green sheets 3s.

When producing the unsintered substrate 1 or 1A, one or more electrolyte layer green sheets 2s and one or more barrier layer green sheets 3s may be pressure bonded after being stacked.

FIG. 7 is a schematic cross-sectional view of an example of firing the unsintered substrate.

The unsintered substrate 1 shown in FIG. 5 is fired at least at a temperature at which the burning-out material 4 is burned out, whereby the unsintered substrate 1 is sintered and the electrolyte layer 20 and the barrier layer 30 are thus formed, and at the same time, the burning-out material 4 is burned out and the pores 40 are thus formed in the barrier layer 30. As a result, the electrolyte substrate 10 shown in FIG. 7 is produced.

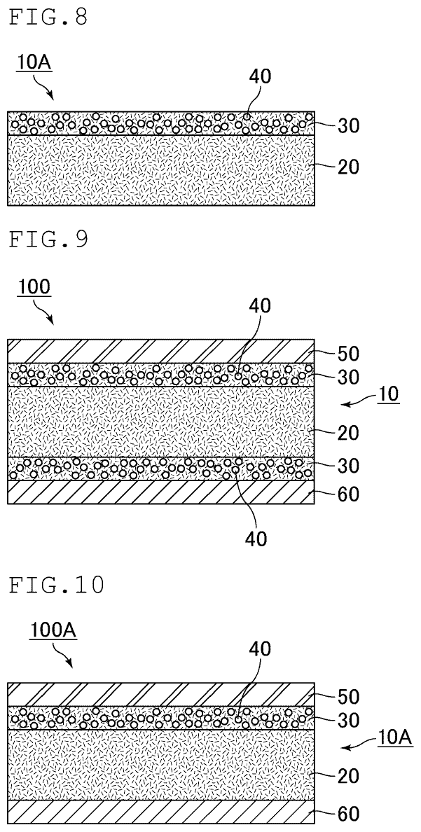

FIG. 8 is a schematic cross-sectional view showing another example of the firing the unsintered substrate.

The unsintered substrate 1A shown in FIG. 6 is fired at least at a temperature at which the burning-out material 4 is burned out, whereby the unsintered substrate 1A is sintered and the electrolyte layer 20 and the barrier layer 30 are thus formed, and at the same time, the burning-out material 4 is burned out and the pores 40 are thus formed in the barrier layer 30. As a result, the electrolyte substrate 10A shown in FIG. 8 is produced.

### Unit Cell for Solid Oxide Fuel Cells

The unit cell for solid oxide fuel cells according to the present disclosure includes an air electrode, a fuel electrode, and the electrolyte substrate according to the present disclosure between the air electrode and the fuel electrode.

The unit cell for solid oxide fuel cells according to the present disclosure includes a barrier layer of the electrolyte substrate between the electrolyte layer of the electrolyte substrate and the air electrode. Thus, the barrier layer can control a reaction between the electrolyte layer and the air electrode.

FIG. 9 is a schematic cross-sectional view of an example of the unit cell for solid oxide fuel cells according to the present disclosure.

A unit cell 100 for solid oxide fuel cells shown in FIG. 9 includes the air electrode 50, a fuel electrode 60, and the electrolyte substrate 10 (see FIG. 1) between the air electrode 50 and the fuel electrode 60.

As described with reference to FIG. 1, the electrolyte substrate 10 includes the electrolyte layer 20 and the barrier layer 30 on each main surface of the electrolyte layer 20. The pores 40 are present in the barrier layer 30.

FIG. 10 is a schematic cross-sectional view of another example of the unit cell for solid oxide fuel cells according to the present disclosure.

A unit cell 100A for solid oxide fuel cells shown in FIG. 10 includes the air electrode 50, the fuel electrode 60, and the electrolyte substrate 10A (see FIG. 2) between the air electrode 50 and the fuel electrode 60.

As described with reference to FIG. 2, the electrolyte substrate 10A includes the electrolyte layer 20 and the barrier layer 30 on one main surface of the electrolyte layer 20. The pores 40 are present in the barrier layer 30.

As shown in FIG. 9 and FIG. 10, the barrier layer 30 of the electrolyte substrate 10 is between the electrolyte layer 20 of the electrolyte substrate 10 and the air electrode 50.

The air electrode 50 may be a known air electrode for solid oxide fuel cells. Examples of materials of the air electrode 50 include La(Ni)FeO₃, (La,Sr)CoO₃, (La,Sr)FeO₃, and (La,Sr) (Co,Fe)O₃. When no barrier layer 30 is between the electrolyte layer 20 and the air electrode 50, high-temperature heat treatment causes a reaction between the air electrode 50 and the electrolyte layer 20, resulting in an insulating layer of SrZrO₃, La₂Zr₂O₇, or the like.

The air electrode 50 may be on the entirety or part of one main surface of the electrolyte substrate 10 or 10A.

The fuel electrode 60 may be a known fuel electrode for solid oxide fuel cells. Examples of materials of the fuel electrode 60 include Ni, Ni/ScSZ (scandia-stabilized zirconia) cermet, Ni/YSZ (yttria-stabilized zirconia) cermet, and Ni/CeO₂ cermet.

The fuel electrode 60 may be on the entirety or part of the other main surface of the electrolyte substrate 10 or 10A.

The unit cell for solid oxide fuel cells according to the present disclosure can be produced by forming an air electrode and a fuel electrode respectively on one main surface and the other main surface of the electrolyte substrate for solid oxide fuel cells according to the present disclosure.

First, a binder and a solvent are added to powdered materials of an air electrode, and further, a dispersant and the like are added thereto as needed, whereby a slurry for an air electrode is prepared. Also, a binder and a solvent are added to powdered materials of a fuel electrode, and further, a dispersant and the like are added thereto as needed, whereby a slurry for a fuel electrode is prepared. The slurry for an air electrode is applied to one main surface of an electrolyte substrate to a predetermined thickness, and the slurry for a fuel electrode is applied to the other main surface of the electrolyte substrate to a predetermined thickness. Then, these coatings are dried, whereby an air electrode green layer and a fuel electrode green layer are formed. The air electrode green layer and the fuel electrode green layer are fired, whereby an air electrode and a fuel electrode are formed. Firing conditions such as a firing temperature may be suitably determined according to, for example, the types of materials of the air electrode and the fuel electrode.

Incorporating the unit cell according to the present disclosure into a solid oxide fuel cell requires an oxidizing gas flow path for supplying an oxidizing gas such as air or oxygen gas to the air electrode, and a fuel gas flow path for supplying a fuel gas such as hydrogen gas, carbon monoxide gas, or hydrocarbon gas to the fuel electrode. The present disclosure also encompasses such a solid oxide fuel cell stack of cells in multiple layers, each cell including the unit cell according to the present disclosure which is provided with an oxidizing gas flow path, a fuel gas flow path, and a conductive path.

### Solid Oxide Fuel Cell Stack

The solid oxide fuel cell stack according to the present disclosure includes a stack of cells in multiple layers, each cell including the unit cell according to the present disclosure, a first interconnector adjacent to the air electrode of the unit cell, and a second interconnector adjacent to the fuel electrode of the unit cell.

In the solid oxide fuel cell stack according to the present disclosure, multiple unit cells are stacked with an interconnector (also referred to as “separator”) therebetween. In other words, each unit cell has a structure that is sandwiched between a pair of interconnectors. The interconnectors have functions to electrically interconnect multiple unit cells and to supply a gas to each electrode.

FIG. 11 is an exploded perspective view of an example of the solid oxide fuel cell stack according to the present disclosure.

A solid oxide fuel cell stack 200 shown in FIG. 11 includes two cells 110 stacked in a Z direction, each cell 110 including the unit cell 100 (see FIG. 9), a first interconnector 210 adjacent to the air electrode 50 of the unit cell 100, and a second interconnector 220 adjacent to the fuel electrode 60 of the unit cell 100. The number of cells 110 to be stacked is not limited. The solid oxide fuel cell stack 200 may include a stack of only the unit cells 100 shown in FIG. 9 or a stack of only the unit cells 100A shown in FIG. 10 or may include a stack of both the unit cell(s) 100 shown in FIG. 9 and the unit cell(s) 100A shown in FIG. 10.

The solid oxide fuel cell stack 200 includes an oxidizing gas manifold 230 and a fuel gas manifold 240, which are through holes. The oxidizing gas manifold 230 extends in an X direction, and the fuel gas manifold 240 extends in a Y direction.

The first interconnector 210 includes an oxidizing gas flow path 250 on its main surface opposite to the air electrode 50. The oxidizing gas flow path 250 extends in the Y direction.

The second interconnector 220 includes a fuel gas flow path 260 on its main surface opposite to the fuel electrode 60. The fuel gas flow path 260 extends in the X direction.

The first interconnector 210 and the second interconnector 220 may be made of insulating materials such as ceramic materials or conductive materials such as metal materials.

The first interconnector 210 and the second interconnector 220 may be made of the same material or different materials.

When the first interconnector 210 and the second interconnector 220 are made of insulating materials, examples of the first interconnector 210 and the second interconnector 220 include sintered partially stabilized zirconia.

When the first interconnector 210 is made of an insulating material, preferably, the first interconnector 210 includes at least one through conductor that penetrates in the thickness direction to be connected to the air electrode 50 and exposed to a main surface on the side opposite to the air electrode 50. In this case, the air electrode 50 can be led out to the outside of the first interconnector 210 via the through conductor.

When the second interconnector 220 is made of an insulating material, preferably, the second interconnector 220 includes at least one through conductor that penetrates in the thickness direction to be connected to the fuel electrode 60 and exposed to a main surface on the side opposite to the fuel electrode 60. In this case, the fuel electrode 60 can be led out to the outside of the second interconnector 220 via the through conductor.

Preferably, the through conductors in the first interconnector 210 and the second interconnector 220 are made of an alloy of silver and palladium, or platinum.

The through conductor in the first interconnector 210 and the through conductor in the second interconnector 220 may be made of the same material or different materials.

### EXAMPLES

Examples that more specifically disclose the electrolyte sheet for solid oxide fuel cells according to the present disclosure are described below. The present disclosure is not limited to these Examples.

### Production of Electrolyte Layer Green Sheets

Scandia-stabilized zirconia Zr(Sc)O₂ (hereinafter described as “ScSZ”) powder, a dispersant, a polyvinyl butyral-based binder, a plasticizer, and a toluene/ethanol-based solvent were mixed to produce a slurry. Subsequently, the viscosity of the slurry was adjusted by vacuum degassing. The slurry was applied to a carrier film by doctor blading and dried, whereby an electrolyte layer green sheet was produced.

### Production of Barrier Layer Green Sheet

Ce(Sm)O₂ (hereinafter described as “SDC”) powder and resin beads (burning-out material) for forming pores were mixed at a predetermined ratio, followed by addition and mixing of a dispersant, a polyvinyl butyral-based binder, a plasticizer, and a toluene/ethanol-based solvent, whereby a slurry was produced. Subsequently, the viscosity of the slurry was adjusted by vacuum degassing. The slurry was applied to a carrier film by doctor blading and dried, whereby a barrier layer green sheet weas produced.

### Production of Electrolyte Substrate

The green sheets were stacked in the order of SDC/ScSZ/SDC and then isostatically pressed at 100 MPa, followed by cutting into a predetermined size, whereby a pressure-bonded article (unsintered substrate) of the green sheets was obtained. Subsequently, the organic components were burned out in a batch-type firing furnace and then sintered at a top temperature of 1350° C., whereby an electrolyte substrate having a size of 50 mm×40 mm was obtained.

### Observation of Cross Section of Electrolyte Substrate

The obtained electrolyte substrate having a size of 50 mm×40 mm was singulated with a grinder into 5 mm square pieces, and these pieces were solidified with thermosetting resin, whereby polishing samples were produced. Each polishing sample was ultimately ground with a 3 μm diamond slurry to expose a smooth cross section of the substrate. Using a scanning electron microscope (SEM) at a magnification of 2000 times, five viewing fields each including an interface between the entire surface in the thickness direction of the barrier layer (SDC layer) and the electrolyte layer (ScSZ layer) were randomly chosen. The presence or absence of a crack was checked, and backscattered electron images were taken.

Each of the electrolyte layer (ScSZ layer) and the barrier layer (SDC layer) was determined as having a crack when at least one crack was observed in the observation field.

The thicknesses of the electrolyte layer (ScSZ layer) and the barrier layer (SDC layer) were measured based on the image scale. Table 1 and Table 2 show the results. The thickness of the barrier layer shown in Table 2 is the thickness of a single barrier layer on one main surface of the electrolyte layer.

### Measurement of Porous Area Percentage

The above-mentioned backscattered electron images were imported into image analysis software (WinROOF2018) and analyzed. The procedure is described below.

(1) A color image is converted into a gray image.

(2) A grayscale detection threshold for gray images was determined to allow the pores to be distinguished from the rest, and points equal to or lower (higher) than the set threshold were detected.

(3) The porous area percentage is calculated based on the following formula from the total porous area and the total barrier layer area.

### Porous Area Percentage (%)=100×Total Porous AREA/Total Barrier Layer Area

### Measurement of 3-Point Bending Strength

The 3-point bending test was performed for the electrolyte substrate using an autograph (AGS-5KNX). Test conditions are described below.

### Length of the Support Span: 20 mm

Test Speed: 5 mm/Min.

The maximum load until fracture of the electrolyte substrate was measured, and the 3-point bending strength was calculated based on the following formula.

σ=3PL/(2bh²)

Here, σ is the 3-point bending strength, P is the maximum load, L is the length of the support span, b is the sample width, and h is the sample thickness. The measurement was performed 10 times, and the average 3-point bending strength was determined.

Table 1 and Table 2 show the evaluation results of the samples. For the 3-point bending strength, Table 2 shows relative values, with the 3-point bending strength of sample No. 2 taken as 1.00.

TABLE 1

| | | | Porous area | Presence or absence | |
|---|---|---|---|---|---|
| | Thickness of | Thickness of | percentage | of crack | |
| Sample | electrolyte | barrier | in barrier | Electrolyte | Barrier |
| No. | layer (μm) | layer (μm) | layer (%) | layer | layer |
| 1* | 100 | 8 | 1 | Absent | Present |
| 2* | 100 | 16 | 1 | Present | Present |

TABLE 2

| | Thickness of | Thickness | Porous area | Presence or absence of crack | | 3-point bending | Separation |
|---|---|---|---|---|---|---|---|
| Sample | electrolyte | of barrier | percentage in | Electrolyte | Barrier | strength | of barrier |
| No. | layer (μm) | layer (μm) | barrier layer (%) | layer | layer | (relative value) | layer |
| 2* | 100 | 16 | 1 | Present | Present | 1.00 | No |
| 3* | 100 | 16 | 13 | Absent | Present | 1.52 | No |
| 4 | 100 | 16 | 24 | Absent | Absent | 1.94 | No |
| 5 | 100 | 16 | 33 | Absent | Absent | 1.97 | No |
| 6 | 100 | 16 | 40 | Absent | Absent | 2.03 | No |
| 7 | 100 | 16 | 52 | Absent | Absent | 2.48 | No |
| 8 | 100 | 16 | 60 | Absent | Absent | 3.48 | No |
| 9 | 100 | 16 | 67 | Absent | Absent | 4.42 | No |
| 10 | 100 | 16 | 72 | Absent | Absent | 5.45 | No |
| 11* | 100 | 16 | 77 | Absent | Absent | 6.52 | Yes |

In Table 1 and Table 2, the samples with*are comparative examples outside the scope of the present disclosure.

Table 1 confirms that in the case of the barrier layers having the same porous area percentage, a barrier layer having a greater thickness is more likely to crack. Presumably, this is because a greater thickness of the barrier layer leads to a greater effect from the difference in thermal expansion or firing shrinkage that occurs between the electrolyte layer and the barrier layer during firing.

According to Table 2, when the porous area percentage in the barrier layer is 24% or more, no cracking was observed in either the electrolyte layer or the barrier layer. In contrast, when the porous area percentage in the barrier layer is less than 24%, presumably, the difference in thermal expansion or firing shrinkage that occurs between the electrolyte layer and the barrier layer during firing is not sufficiently reduced.

Table 2 confirms that in the case of the barrier layers having the same thickness, a barrier layer having a higher porous area percentage has a higher 3-point bending strength. Presumably, this is due to effects such as a reduction in residual stress (i.e., tensile stress to the surface of the barrier layer) owing to the reduction in the difference in thermal expansion during firing, and stoppage of crack growth with the pores even in the event of cracking.

Table 2 confirms that in the case of the barrier layer having a porous area percentage of 77%, the barrier layer is separated from the electrolyte layer and turned into powder, for example, due to friction between the substrates that occurs during normal handling. Presumably, this is caused by a decrease in the area where the barrier layer and the electrolyte layer are bonded together, and also by a decrease in strength of the barrier layer itself. If the above phenomenon occurs before the air electrode is formed, the effect of controlling a reaction between the air electrode and the electrolyte layer will be reduced. If the above phenomenon occurs after the air electrode is formed, reaction sites will decrease, resulting in a decrease in battery characteristics.

Based on the above results, an appropriate range of the porous area percentage in the barrier layer is presumed to be 24% to 72%.

### REFERENCE SIGNS LIST

1, 1A unsintered substrate
2 unsintered electrolyte layer
2s electrolyte layer green sheet
3 unsintered barrier layer
3s barrier layer green sheet
4 burning-out material
5 scandia-stabilized zirconia powder or yttria-stabilized zirconia powder
6 Ce(X)O₂ powder
10, 10A electrolyte substrate for solid oxide fuel cells
20 electrolyte layer
30 barrier layer
40 pore
50 air electrode
60 fuel electrode
100, 100A unit cell for solid oxide fuel cells
110 cell
200 solid oxide fuel cell stack
210 first interconnector
220 second interconnector
230 oxidizing gas manifold
240 fuel gas manifold
250 oxidizing gas flow path
260 fuel gas flow path

1. An electrolyte substrate for solid oxide fuel cells, the electrolyte substrate comprising:
an electrolyte layer containing sintered scandia-stabilized zirconia or sintered yttria-stabilized zirconia; and
a first barrier layer on a first main surface of the electrolyte layer, and a second barrier layer on a second main surface of the electrolyte layer, each of the first barrier layer and the second barrier layer containing sintered Ce(X)O₂, where X is any one of Sm, Gd, and Y,
wherein in a cross-sectional view in a thickness direction of the first barrier layer and the second barrier layer, pores are present with an area percentage of 24% to 72% in each of the first barrier layer and the second barrier layer.

2. The electrolyte substrate according to claim 1, wherein a ratio of a thickness of at least one of the first barrier layer and the second barrier layer to a thickness of the electrolyte layer is 20% or less.

3. The electrolyte substrate according to claim 1, wherein a ratio of a thickness of at least one of the first barrier layer and the second barrier layer to a thickness of the electrolyte layer is 1% to 20%.

4. The electrolyte substrate according to claim 1, wherein a thickness of at least one of the first barrier layer and the second barrier layer is 20 μm or less.

5. The electrolyte substrate according to claim 1, wherein a thickness of at least one of the first barrier layer and the second barrier layer is 1 μm to 20 μm.

6. The electrolyte substrate according to claim 1, wherein a ratio of a thickness of each of the first barrier layer and the second barrier layer to a thickness of the electrolyte layer is 20% or less.

7. The electrolyte substrate according to claim 1, wherein a ratio of a thickness of each of the first barrier layer and the second barrier layer to a thickness of the electrolyte layer is 1% to 20%.

8. The electrolyte substrate according to claim 1, wherein a thickness of each of the first barrier layer and the second barrier layer is 20 μm or less.

9. The electrolyte substrate according to claim 1, wherein a thickness of each of the first barrier layer and the second barrier layer is 1 μm to 20 μm.

10. The electrolyte substrate according to claim 1, wherein a thickness of each of the first barrier layer and the second barrier layer and the area percentage of the pores in the first barrier layer and the second barrier layer are the same in each of the first barrier layer and the second barrier layer.

11. The electrolyte substrate according to claim 1, wherein the area percentage of the pores in at least one of the first barrier layer and the second barrier layer is 24% to 33%, or 67% to 72%.

12. The electrolyte substrate according to claim 1, wherein the area percentage of the pores in at least one of the first barrier layer and the second barrier layer is 24% to less than 40%, or more than 60% to 72%.

13. The electrolyte substrate according to claim 1, wherein the area percentage of the pores in each of the first barrier layer and the second barrier layer is 24% to 33%, or 67% to 72%.

14. The electrolyte substrate according to claim 1, wherein the area percentage of the pores in each of the first barrier layer and the second barrier layer is 24% to less than 40%, or more than 60% to 72%.

15. A unit cell for solid oxide fuel cells, the unit cell comprising:
an air electrode;
a fuel electrode; and
the electrolyte substrate according to claim 1 between the air electrode and the fuel electrode,
wherein at least one of the first barrier layer and the second barrier layer of the electrolyte substrate is between the electrolyte layer of the electrolyte substrate and the air electrode.

16. A solid oxide fuel cell stack comprising:
cells in multiple layers, each cell including the unit cell according to claim 15;
a first interconnector adjacent to the air electrode of the unit cell; and
a second interconnector adjacent to the fuel electrode of the unit cell.

17. A method for producing an electrolyte substrate for solid oxide fuel cells, the method comprising:
producing an unsintered substrate including a first unsintered barrier layer on a first main surface of an unsintered electrolyte layer or on a first main surface of a sintered electrolyte layer, and a second unsintered barrier layer on a second main surface of the unsintered electrolyte layer or on a second main surface of the sintered electrolyte layer, each of the first unsintered barrier layer and the second unsintered barrier layer containing Ce(X)O₂ powder, where X is any one of Sm, Gd, and Y, and a burning-out material, the unsintered electrolyte layer containing scandia-stabilized zirconia powder or yttria-stabilized zirconia powder, the sintered electrolyte layer containing sintered scandia-stabilized zirconia or sintered yttria-stabilized zirconia; and
firing the unsintered substrate at least at a temperature at which the burning-out material is burned out.

18. The method for producing an electrolyte substrate according to claim 17,
wherein the producing of the unsintered substrate comprises:
producing an unfired electrolyte layer green sheet containing scandia-stabilized zirconia powder or yttria-stabilized zirconia powder;
producing a first unfired barrier layer green sheet and a second unfired barrier layer green sheet, each of the first unfired barrier layer green sheet and the second unfired barrier layer green sheet containing the Ce(X)O₂ powder and the burning-out material; and
stacking the electrolyte layer green sheet, the first barrier layer green sheet, and the second barrier layer green sheet.

19. The method for producing an electrolyte substrate according to claim 17, wherein the burning-out material comprises resin beads.
